(19) United States
(12) Patent Application Publication
(10) Pub. No.: US 2022/0368150 A1
(43) Pub. Date: Nov. 17, 2022

(54) VOLTAGE GRADIENT-BIASED CONTROLLER, SYSTEM AND METHOD FOR CONTROLLING DISCHARGE OF HETEROGENEOUS BATTERY PACKS

(71) Applicants: China Energy Investment Corporation Limited, Beijing (CN); National Institute of Clean-and-Low-Carbon Energy, Beijing (CN)

(72) Inventors: Ratnesh Sharma, Fremont, CA (US); Brandon Ohara, Mountain View, CA (US); Surinder Singh, Fremont, CA (US)

(73) Assignees: China Energy Investment Corporation Limited, Beijing (CN); National Institute of Clean-and-Low-Carbon Energy, Beijing (CN)

(21) Appl. No.: 17/241,528

(22) Filed: Apr. 27, 2021

(51) Int. Cl. H02J 7/00

(52) U.S. Cl. CPC H02J 7/007184; H02J 7/0047; H02J 7/0063; H02J 7/0013; H02J 7/00036

(57) ABSTRACT

A controller, a system including such a controller, and a method for controlling discharging of a plurality of battery packs are provided. The controller includes one or more processor and at least one tangible, non-transitory machine readable medium encoded with one or more programs configured to perform steps to minimize a corresponding voltage gradient versus charge of each battery pack to be below a predetermined threshold, and calculate a respective discharging share of each battery pack based on the charge and the voltage in an updated curve of voltage versus charge of each battery pack and the total power demand. The controller provides signals with instructions to the plurality of battery packs and/or the one or more power converters for discharging power from the plurality of battery packs based on the respective discharging share of each battery pack and/or keeping a certain battery pack idle.

### PRIORITY CLAIM AND CROSS-REFERENCE

None.

### FIELD OF THE INVENTION

The disclosure relates to systems and methods for controlling battery packs generally. More particularly, the disclosed subject matter relates to a controller, a system, and a method for controlling discharge of battery packs, for example, in energy storage application.

### BACKGROUND

Clean and renewable sources of energy become more important due to increased concerns about environmental issues such as global warming. Such sources include solar and wind power, and rechargeable battery. Renewable energy sources are intermittent because they cannot always be dispatched when needed to meet the changing requirements of energy consumers. Energy storage systems are expected to solve this flexibility challenge. A stationary energy storage system can store energy and release energy in the form of electricity when it is needed.

### SUMMARY OF THE INVENTION

The present disclosure provides a controller for controlling discharge of heterogeneous battery packs, an electrical energy storage system comprising such a controller, and methods of using the same. In accordance with some embodiments, the controller, the system, and the method utilize a voltage gradient-biased technique.

In accordance with some embodiments, a system comprises a plurality of battery packs, one or more power converters, and a controller. Each power converter is coupled with at least one of the plurality of battery packs, and is configured to convert direct current (DC) from one battery pack to alternating current (AC) or vice versa. The controller is coupled to the plurality of battery packs and the one or more power converters. In some embodiments, the system may also include more than one controller, and each controller is coupled to a plurality of battery packs.

The plurality of battery packs are defined and described herein. In some embodiments, the plurality packs are heterogeneous battery packs, which can be selected from new batteries, second-use electric vehicle (EV) batteries, or combinations thereof. The plurality of battery packs are connected in parallel, in series, or in a combination (i.e. hybrid combinations) thereof. In some embodiments, the plurality of battery packs are connected in parallel.

The controller comprises one or more processors and at least one tangible, non-transitory machine readable medium encoded with one or more programs configured to perform steps for controlling a discharging process of the system having the plurality of battery packs. In some embodiments, these steps include: receiving a total power demand (or called power load) needed to be dispatched from the system, collecting characteristic data of each battery pack to establish a first curve of voltage versus charge for each battery pack, determining a voltage gradient for each battery pack based on the first curve of voltage versus charge, and changing charge and voltage of a respective battery pack so as to control and/or reduce a corresponding voltage gradient for every battery pack to be below a predetermined threshold. The changed charge and voltage form a second curve of voltage versus charge for each respective battery pack.

The steps further include: calculating a respective discharging share of each battery pack based on the charge and the voltage in the second curve of voltage versus charge of each battery pack and the total power demand needed to be dispatched, and providing signals with instructions to the plurality of battery packs and the one or more power converters for discharging power from the plurality of battery packs based on the respective discharging share or rate of each battery pack and/or keeping a certain battery pack idle.

When the calculated discharging share or rate of a certain battery pack is about zero, or such a battery cannot be used to discharge to meet the required conditions, the specific battery pack is kept idle without discharging. Such a battery pack may need to be charged first or replaced.

In some embodiments, the step of reducing and/or controlling a corresponding voltage gradient for every battery pack comprises steps of: identifying a maximum voltage gradient and a corresponding first battery pack among the plurality of battery packs, and reducing or minimizing the maximum voltage gradient of the corresponding first battery pack to be below the predetermined threshold by changing its charge and corresponding voltage. It is assumed that the plurality of battery packs are used for discharging and power dispatch. The steps of identifying and minimizing the maximum voltage gradient are then repeated among other packs as a remainder of the plurality of battery packs to establish a second curve of voltage versus charge for each battery pack. Thus, a voltage gradient distribution curve is established for each of the plurality of battery packs.

In some embodiments, the controller is configured to provide the signal with instructions for a pre-determined time interval, and re-assign dispatch for the plurality of battery packs after the time interval ends or when a voltage collapse occurs to a battery pack, by repeating some or all of the steps described above. In some embodiments, the controller is also configured to dynamically control discharging of the plurality of battery packs by updating the respective discharging share or rate of each battery pack instantaneously with time.

The system may optionally further comprise one or more battery power management unit (BPMU). Each BPMU may be connected with one or more battery packs, and is configured to monitor the one or more battery packs and provide characteristic data of the one or more battery packs to the controller.

In some embodiments, the system is an electrical energy storage system. The total power demand is provided from an upper level energy management system (EMS). In some embodiments, the controller is configured to discharge power from the plurality of battery packs to a grid or load. In some embodiments, the grid is optional. The power can be discharged to other components, in which electrical power is needed.

In another aspect, the present disclosure provides a controller for controlling discharge of a system comprising a plurality of battery packs. As described herein, such a controller comprises one or more processor and at least one tangible, non-transitory machine readable medium encoded with one or more programs configured to perform the steps as described herein. The controller is configured to perform the steps of: receiving a total power demand needed to be dispatched from the system, collecting characteristic data of each battery pack to establish a first curve of voltage versus charge for each battery pack, determining a voltage gradient for each battery pack based on the first curve of voltage versus charge, and changing charge and voltage of a respective battery pack so as to control and/or reduce a corresponding voltage gradient of each battery pack to be below a predetermined threshold in a second curve of voltage versus charge. The controller is also configured to calculate a respective discharging share or rate of each battery pack based on the charge and the voltage in the second curve of voltage versus charge of each battery pack and the total power demand needed to be dispatched, and providing signals with instructions to the plurality of battery packs and/or one or more power converters for discharging power from the plurality of battery packs based on the respective discharging share of each battery pack and/or keeping a certain battery pack idle as described herein.

The step of reducing and/or controlling voltage gradient of each battery pack comprises steps of: identifying a maximum voltage gradient and a corresponding first battery pack among the plurality of battery packs, and minimizing the maximum voltage gradient of the corresponding first battery pack to be below the predetermined threshold by changing its charge and corresponding voltage. The steps of identifying and minimizing the maximum voltage gradient are repeated among a remainder of the plurality of battery packs to establish a second curve of voltage versus charge for each battery pack.

The plurality of battery packs, which the controller is configured to be coupled with, are heterogeneous battery packs selected from new batteries, second-use electric vehicle (EV) batteries, or combinations thereof. The plurality of battery packs are connected in parallel, in series, or in a combination thereof. In some embodiments, the controller is configured to provide the signal with instructions for a pre-determined time interval, and re-assign dispatch for the plurality of battery packs after the time interval ends or when a voltage collapse occurs to a battery pack, by repeating some or all of the steps described above. The controller is configured to dynamically control discharging of the plurality of battery packs by updating the respective discharging share of each battery pack instantaneously with time.

The controller is configured for controlling discharge of heterogeneous battery packs, for example, in an electrical energy storage system. In some embodiments, the controller is configured to optionally discharge power from the plurality of battery packs to a grid or load.

In another aspect, the present disclosure provides a method for controlling discharge of a system comprising a plurality of battery packs through a controller therein as described herein. The method includes steps of: receiving a total power demand needed to be dispatched from the system, collecting characteristic data of each battery pack to establish a first curve of voltage versus charge for each battery pack, determining a voltage gradient for each battery pack based on the first curve of voltage versus charge, and controlling the voltage gradient for each battery pack to be below a predetermined threshold by changing charge and corresponding voltage of a respective battery pack to provide a second curve of voltage versus charge.

The method further includes steps of: calculating a respective discharging share of each battery pack based on the charge and the voltage in the second curve of voltage versus charge of each battery pack and the total power demand needed to be dispatched, and discharging power from the plurality of battery packs based on the respective discharging share of each battery pack.

The step of controlling and/or reducing a corresponding voltage gradient of each battery pack comprises steps of: identifying a maximum voltage gradient and a corresponding first battery pack among the plurality of battery packs, and minimizing the maximum voltage gradient of the corresponding first battery pack to be below the predetermined threshold by changing its charge and corresponding voltage. It is assumed that the plurality of battery packs are used for discharging and power dispatch. The steps of identifying and minimizing the maximum voltage gradient are then repeated among a remainder of the plurality of battery packs to establish a second curve of voltage versus charge for each battery pack. In some embodiments, the order in which the battery packs are selected for the calculation is not critical.

In some embodiments, a certain battery pack may be kept in idle if a respective discharging share of a certain battery pack is about zero, or cannot be used under the condition constraints.

The plurality of battery packs are heterogeneous battery packs selected from new batteries, second-use electric vehicle (EV) batteries, or combinations thereof. The plurality of battery packs are connected in parallel, in series, or in a combination thereof.

In some embodiments, instructions are sent from the controller to each battery pack and/or one or more converter connected with the plurality of battery packs for discharging based on the respective discharging share of each battery pack.

In some embodiments, the method includes repeating some or all the steps to re-assign dispatch for the plurality of battery packs after the time interval ends or when a voltage collapse occurs to a battery pack. In some embodiments, the discharging process of the plurality of battery packs is dynamically controlled by updating the respective discharging share or rate of each battery pack instantaneously with time.

The system, the controller, and the method provided in the present disclosure offer many advantages. For example, a variety of new and used battery packs having different quality can be used. No pre-selection or dismantle of the battery packs are needed. The plurality of heterogeneous battery packs collectively supply power load to satisfy the power demand while each battery pack may discharge at a different share or rate. The system, the controller, and the method extend the life of each battery packs, and they also offer flexibility in maintaining and upgrading the system as well.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 is a block diagram illustrating an exemplary system comprising heterogeneous battery packs and a controller in accordance with some embodiments.

FIG. 2 is a block diagram illustrating an exemplary controller comprising one or more processor and at least one tangible, non-transitory machine readable medium encoded with one or more programs, for controlling discharge of a plurality of heterogeneous battery packs in accordance with some embodiments.

FIG. 3 shows the relationship between voltage (V) and charge flow (Ah) of an exemplary battery pack in some embodiments.

FIG. 4 shows that the dispatch shares of battery packs (Ωᵢ) are calculated iteratively to minimize voltage gradient while satisfying the dispatch constraint, in accordance with some embodiments.

FIGS. 5A-5B are flow charts illustrating an exemplary method for controlling discharge of battery packs in accordance with some embodiments.

FIG. 6 is a flow chart illustrating an exemplary program for controlling discharge of battery packs in accordance with some embodiments.

FIG. 7 shows two exemplary battery packs with different voltages being dispatched with the program and algorithm provided in the present disclosure.

FIG. 8 shows the changes in power dispatch of the two exemplary battery packs in FIG. 7 with time, as compared to those of the same battery packs using the existing technologies.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

U.S. Patent Application Publication No. 2010/0285339A1 discloses a method for charging a discharging an electrochemical battery system such as a Li-ion battery system having two cells. The battery discharge is determined based on the state of charge (SOC) thresholds defined in the system. The criteria to discharge the second cell in this system is based on the criteria associated with the first cell, rather than its own status. Australian Patent Application No. AU2018236771B2 describes a multi-source distributed energy storage. However, in such a system, no two groups of sources may be operated at a single time.

Chinese Patent Application No. CN110518667A discloses an echelon to utilize a battery parallel system including a battery module and DC/DC power converter module. In such a battery module, multiple groups of battery packs are parallel with one another, and every group of battery pack is composed of by several battery packs in series, respectively. The battery packs are connected in series to provide a similar voltage in a respective group of battery packs connected in parallel. The system utilizes DC/DC converters and a battery management module in the battery module to control a battery system.

Such a system disclosed in CN110518667A ignored the variety of new or used batteries and existing circulating currents among the series packs. The technique disclosed limits the expansion of such a system into a power grid. A DC-to-DC converter is an electronic circuit or electromechanical device that converts a source of direct current (DC) from one voltage level to another. Additional AC/DC converters are still required if a battery system is connected to a power grid. Adding more DC/DC converters will significantly raise the total DC current and increase hardware requirement on the AC/DC converters if the system such as that disclosed in CN110518667A is connected to a power grid.

The present disclosure provides a controller for controlling discharge of heterogeneous battery packs, an electrical energy storage system comprising such a controller, and methods of using the same. In accordance with some embodiments, the controller, the system, and the method utilize a voltage gradient-biased technique. Multiple battery groups can be discharged at the same time. The priority of the discharge and dispatch shares or rates for a plurality of battery packs are determined by the voltage bias as described herein.

One of the objectives in the present disclosure is to establish a method for discharging a plurality of battery packs based on the data of current (or interpolation of historical current) and battery pack voltage collected from the battery packs. Such data are used to establish curves of voltage versus charge, based on which a voltage gradient of each battery pack is calculated. The voltage gradient provides a measure of the state of charge of such a battery pack and its ability to supply energy. Packs that show lower voltage gradient are dispatched on a priority to provide higher power than packs at higher voltage gradient.

Power dispatch (discharge) is a function of charge flow and voltage. Lower voltage gradient provides more stable energy supply compared to high voltage gradient for the same amount of charge flow. Earlier approaches have not considered the impact of voltage gradient on the decision of energy dispatch. Moreover, heterogeneity of the voltage gradients of battery packs have not been considered.

The present disclosure provides a controller, a system, and a method to properly utilize heterogeneous batteries such as new batteries from different manufactures or second-use electric vehicle (EV) battery packs in stationary energy storage applications. Every battery pack is operated individually according to its characters such as voltage gradient. Preselecting or dismantling packs is not required.

One benefit of the invention is to efficiently manage the diversity of battery packs such as new batteries, second use EV battery packs, or combinations thereof in stationary energy storage applications. The utilization rates of stronger (healthier) packs among a multi-pack system can be improved. The length of lives of EV battery packs can be evened and overall life the system can be extended. The reliability, stability, and safety of battery energy storage system (BESS) are improved. Additionally, the voltage gradient method provided in the present disclosure ensures all or most of the battery packs to collectively provide power demand for longer periods without individual packs reaching their voltage cutoffs too soon. Hence, a shared power supply is maintained without over stressing healthier packs.

The controller, the system, and the method provided in the present disclosure apply to different battery packs, which are heterogeneous battery packs. References to “heterogeneous battery packs” made herein refer to battery packs or modules having different capacity, state of charge (SOC), state of heath (SOH), and/or voltage gradients, and can be selected from new batteries (e.g., from different manufacturers), second-use electric vehicle (EV) batteries, or combinations thereof. Second-use EV batteries are used for illustration purpose. References to “discharging” from or “charging” to the plurality of battery packs are understood that the plurality of batteries packs collectively discharge or be charged, while it is possible that some battery packs may stay idle (without charging or discharging).

Unless expressly indicated otherwise, references to “state of health (SOH)” made herein will be understood to mean a figure of merit of the condition of a battery, a battery cell, or a battery pack compared to its ideal conditions. SOH is characterized in percentage (%). The condition matching the specifications under the ideal conditions is 100%. SOH may decrease over time and use.

Unless expressly indicated otherwise, “state of charge” (SOC) described herein is defined as a level of charge of an electric battery relative to its capacity. The units of SOC are percentage points, 0% means empty, and 100% means full.

The term “human machine interface (HMI)” used herein is understood to refer to user interface (UI) is the space where interactions between humans and machines occur. A human-machine interface (HMI) may involve interfaces between human and machines with physical input hardware such as keyboards, mice, or any other human interaction based on tactile, visual, or auditory senses. Such user interfaces may include other layers such as output hardware such as computer monitors, speakers, and printers.

The term “energy management system (EMS)” used herein refers to a system of computer-aided tools used by operators of electric utility grids to monitor, control, and optimize the performance of the generation or transmission system.

In the present disclosure, the terms “power demand” and “power requirement” are used interchangeably, and the terms “converter” and “inverter” can be used interchangeably. Each battery pack includes an inverter and a battery management unit (BMU) therein. For the convenience of description, the term “power inverter” or “AC/DC power converter” is used to describe the internal component in a battery pack, and the term “power converter” or “power conversion system (PCS)” is used to describe the converter connected with one or more battery packs. The term of “battery management unit (BMU)” or “battery management system (BMS)” is used to describe the internal component in a battery pack, and the term “battery power management unit (BPMU)” is used to describe the battery management unit connected with one or more battery packs.

In the present disclosure, the terms “power” and “energy” are used interchangeably, and the energy are described in a unit of time. Energy and power can be converted with time.

Unless expressly indicated otherwise, the term “connected” or “coupled” used herein are understood to encompass different connections or coupling between or among the components so as to conduct electricity or transmit signals for communication. Such a connection or coupling can be through wire, wireless, or cloud-based modes.

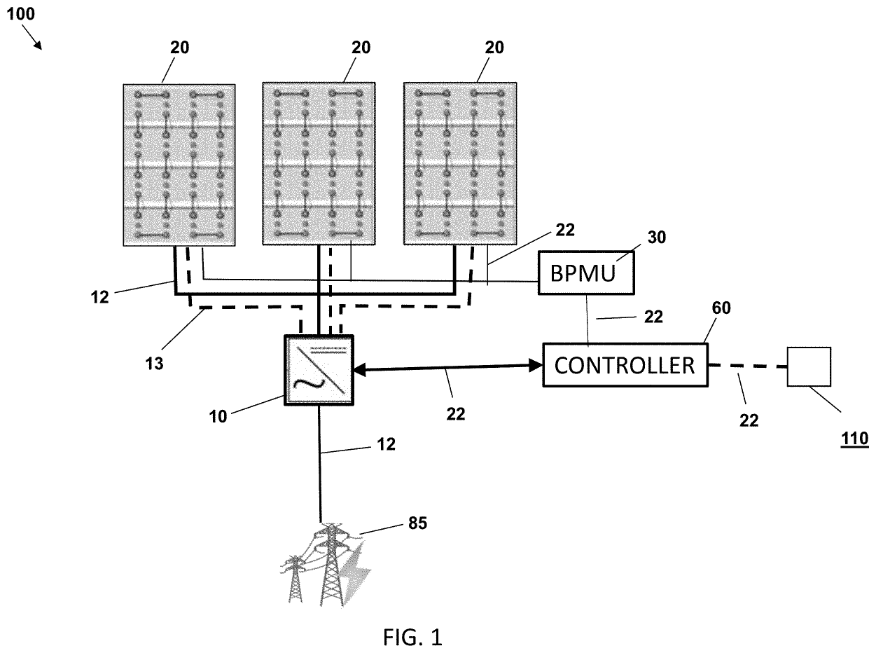

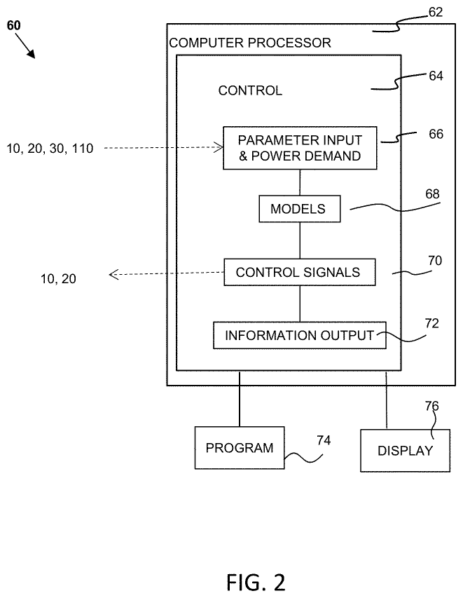

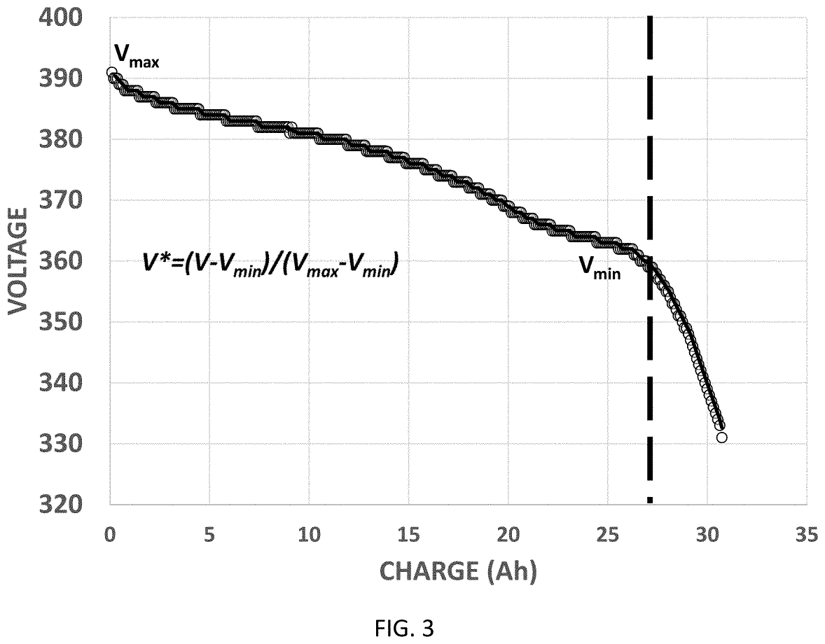

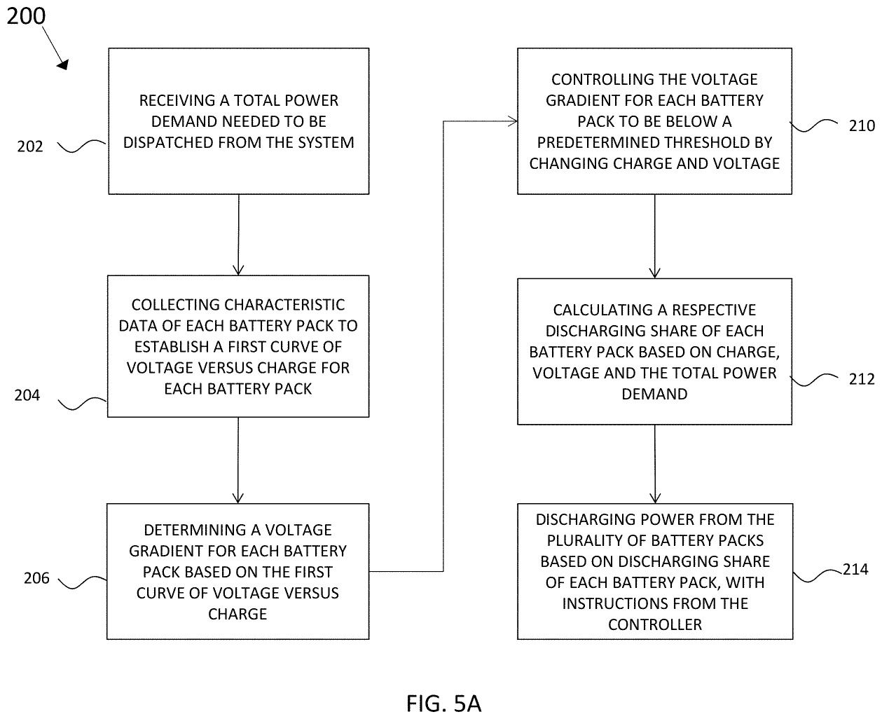

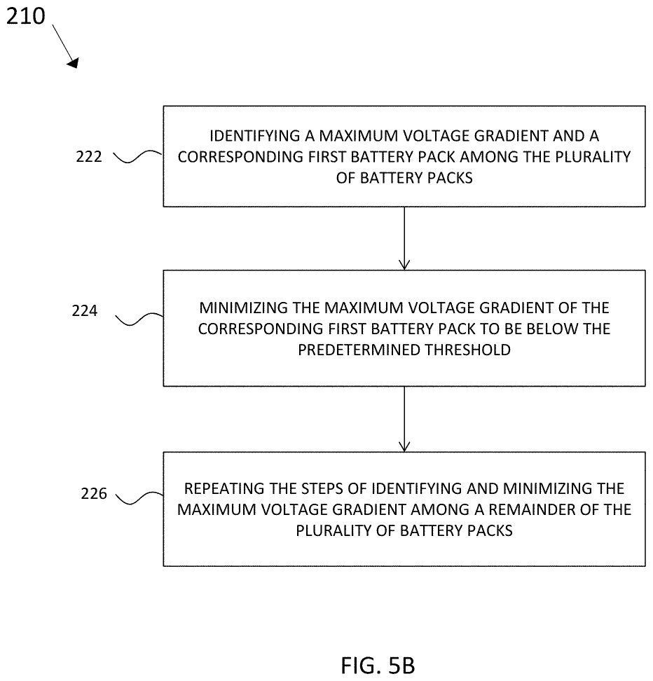

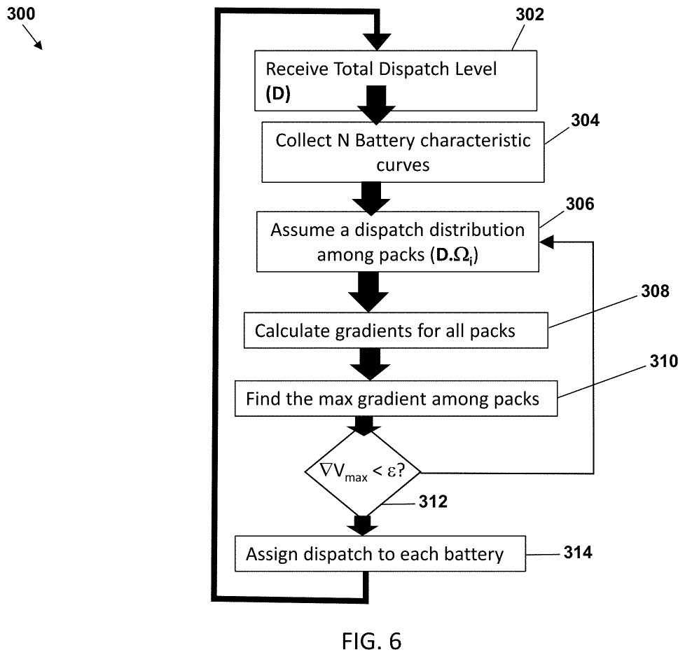

In FIGS. 1-2, like items are indicated by like reference numerals, and for brevity, descriptions of the structure, provided above with reference to the preceding figures, are not repeated. The methods described in FIGS. 5-6 are described with reference to the exemplary structure described in FIGS. 1-2 and the data plots or sketches described in FIGS. 3-4 and 7-8.

Referring to FIG. 1, an exemplary system 100 comprises one or more power converters 10, a plurality of battery packs 20, and a controller 60. The number of each component and the configuration in FIG. 1 are for illustration only. The system may have any suitable number of each component in any suitable combination or configuration.

Each power converter 10 is coupled with at least one of the plurality of battery packs 20, and is configured to convert direct current (DC) from a battery pack to alternating current (AC) or vice versa. The power converter 10 can be also called as power conversion system (PCS) or an inverter.

The controller 60 is coupled to the plurality of battery packs 20 and the one or more power converters 10. In some embodiments, the system may also include more than one controller 60, and each controller 60 is coupled to a plurality of battery packs 20.

The controller 60 may be coupled to the plurality of battery packs 20 directly or indirectly. For example, in some embodiments, the exemplary system 100 may optionally further comprise one or more battery power management unit (BPMU), which can be also called battery management unit (BMU). Each BPMU 30 may be connected with one or more battery packs 20, and is configured to monitor the one or more battery packs 20 and provide characteristic data of the one or more battery packs 20 to the controller 60. In some embodiments, the controller 60 is configured to read the data from each battery pack 20. This may be done through each respective BPMU 30 connected with each battery pack.

The plurality of battery packs 20 are heterogeneous battery packs, which can be selected from new batteries, second-use electric vehicle (EV) batteries, or combinations thereof. The plurality of battery packs 20 are connected in parallel, in series, or in a combination thereof. In some embodiments, the plurality of battery packs 20 are connected in parallel. No series connection between battery packs eliminates circulating currents and losses.

As shown in FIG. 1, the plurality of battery packs 20 are connected in a parallel configuration 50. In some embodiments, the plurality of battery packs 20 are second-use (i.e. used) electric vehicle (EV) batteries. The used EV batteries can be directly utilized in the system, without pre-selection or dismantling. Each battery pack 20 comprises a battery or batteries. Each battery packs 20 may include an internal battery management unit (BMU), and an internal inverter. EV battery packs 20 are removed from vehicles and are not disassembled into modules. Simple tests may be done on these EV battery packs 20 to verify their SOH.

In some embodiments, the exemplary system 100 is an electrical energy storage system. The controller 60 is configured to receive a total power demand provided from an upper level energy management system (EMS) 110. In some embodiments, the controller 60 is configured to discharge power from the plurality of battery packs 20 in direct current to a grid or load 85 in alternating current. The exemplary system 100 can be used for discharging power from battery packs 20 to a grid 85, or for charging from the grid 85 to battery packs 20. Wire connection 12 may be used. The dotted lines 13 in FIG. 1 illustrates alternative power cables. Multiple power cable topologies may exist between the converter 10 and battery packs 20. The system 100 directly uses grid tied AC/DC converters 10 with flexibility in size expansion. No additional power conversion system is required for grid tied applications.

In some embodiments, the grid 85 is optional. The power can be discharged to other components, in which electrical power is needed.

The controller 60 may be connected with other components in wire or wireless mode. In the exemplary system 100 illustrated in FIG. 1, the controller 60 may be connected with other components such as converter 10, BPMU 30 and EMS 110 via data cable or wireless connection 22. The BPMU 30 may be also connected with battery packs 20 via data cables or wireless connection 22. The controller 60 can work in a cloud-based mode.

Each battery pack 20 may be connected to a power converter 10 (or independent DC port on a converter 10) through a set of automatic DC circuit breakers (not shown), which activate and control the connection between a battery pack 20 and the converter 10. The converter 10 controls whether or not to charge or discharge the single EV battery pack 20 by following the instructions from the controller 60.

Referring to FIG. 2, the controller 60 comprises one or more processors 62 and at least one tangible, non-transitory machine readable medium encoded with one or more programs configured to perform steps for controlling a discharging process of the system having the plurality of battery packs. The controller 60, the processor 62, and/or the program 74 may be an external device to the converter 10, or be an internal device inside the converter 10.

The processor(s) 62 may include a central control 64, which includes a parameter input module 66, model module 68, a parameter control module 70, and information and instruction module 72. The parameter input module 66 coordinates with the battery packs 20, optionally BPMU 30 and HMI or EMS 110, to read the data from battery packs 20 and power demand from HMI or EMS 110. The parameter input module 66 also coordinates with each power converter 10. The parameter control module 70 coordinates with each power converter 10 and each battery pack 20, and optionally with BPMU 30 and HMI or EMS 110 to control a process of discharging. Together with the one or more programs 74, the model module 68 is configured to perform a simulation based on the input parameters to provide information and instruction to the parameter control module 70 and the information and instruction module 72. The processors 62 may be optionally connected with one or more displays 76 for displaying the information and instructions from module 72 and to an operator.

The controller 60 with the programs 74 and the processor 62 is configured to perform steps for discharging or charging as described herein. As described in FIGS. 5-6, in some embodiments, the controller 60 is configured to perform the steps including: receiving a total power demand (D) needed to be dispatched from the system 100, collecting characteristic data of each battery pack 20 to establish a first curve of voltage versus charge for each battery pack 20, determining a voltage gradient for each battery pack based on the first curve of voltage versus charge, and changing charge and voltage of a respective battery pack 20 so as to control and/or reduce a corresponding voltage gradient of each pack to be below a predetermined threshold (ε) in a second curve of voltage versus charge. The steps further include: calculating a respective discharging share of each battery pack 20 based on the charge and the voltage in the second curve of voltage versus charge of each battery pack 20 and the total power demand needed to be dispatched, and providing signals with instructions to the plurality of battery packs 20 and the one or more power converters 10 for discharging power from the plurality of battery packs 20 based on the respective discharging share or rate of each battery pack and/or keeping a certain battery pack idle. The discharging or dispatch share refers to the percentage of power or energy a battery pack discharges in the power demand (D). The discharging or dispatch rate refers to the power or energy discharged per unit of time.

When the calculated discharging share or rate of a certain battery pack is about zero, or such a battery cannot be used to discharge to meet the required conditions, the specific battery pack is kept idle without discharging. Such a battery pack may need to be charged first or replaced.

In some embodiments, the step of changing charge and voltage of a respective battery pack 20 so as to control and/or reduce a corresponding voltage gradient comprises steps of: identifying a maximum voltage gradient and a corresponding first battery pack among the plurality of battery packs, and reducing or minimizing the maximum voltage gradient of the corresponding first battery pack to be below the predetermined threshold (ε) by changing its charge and corresponding voltage. It is assumed that the plurality of battery packs 20 are used for discharging and power dispatch. The steps of identifying and minimizing the maximum voltage gradient are then repeated among other packs as a remainder of the plurality of battery packs 20 to establish a second curve of voltage versus charge for each battery pack 20. Thus, a voltage gradient distribution curve is established for each of the plurality of battery packs 20.

In some embodiments, the controller 60 is configured to provide the signal with instructions for a pre-determined time interval, and re-assign dispatch for the plurality of battery packs after the time interval ends or when a voltage collapse occurs to a battery pack, by repeating the steps described above. In some embodiments, the controller 60 is also configured to dynamically control discharging of the plurality of battery packs by updating the respective discharging share or rate of each battery pack instantaneously with time.

The present disclosure provides a controller as described herein for controlling discharge of a system comprising a plurality of battery packs. The controller is configured for controlling discharge of heterogeneous battery packs, for example, in an electrical energy storage system.

The present disclosure also provides a method for controlling discharge of a system comprising a plurality of battery packs through a controller therein as described herein.

Such a method is used to dispatch battery packs with heterogeneous health conditions to provide a consistent and long-lasting dispatch profile. The method relies on voltage gradient-weighted discharge of individual battery packs to provide least impact on charge throughput while maximixing the energy output. Additionally, this improves management of the system, including operation on weaker batteries (i.e. batteries that demonstrate steep decline in voltage during normal discharge).

For most battery chemistries, healthy batteries show little drop in voltage during normal window of charging or discharging. Therefore, a drop in voltage during discharging process is an indication of health issues. The method relies on using the voltage drop during discharge process to dynamically assess the health of a battery pack and utilize this gradient to bias the dispatch from each pack. Reduced throughput leads to improved life and performance through the useful life of the battery pack.

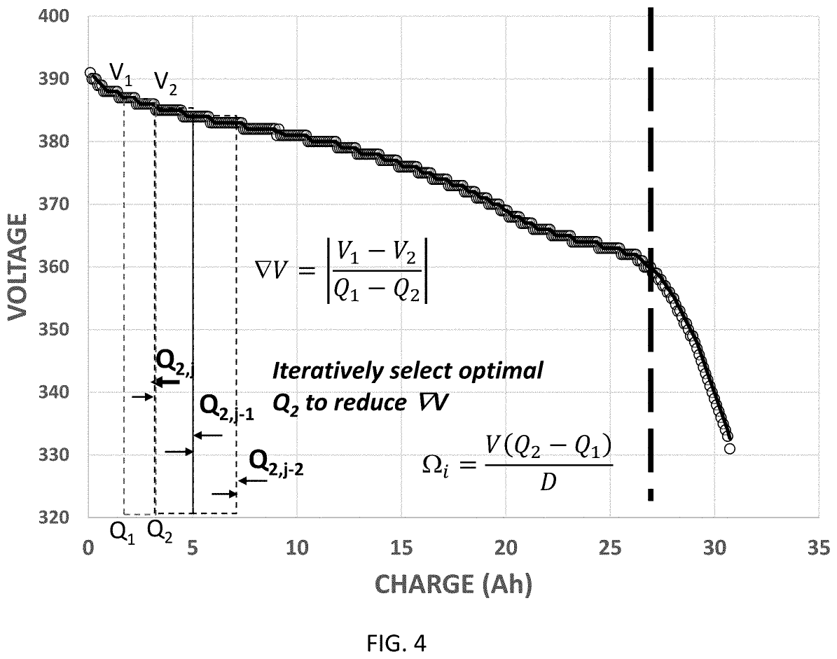

FIGS. 3-4 are used to illustrate the principle for the method and the programs used in the controller 60.

Referring to FIG. 3, a curve of voltage with charge flow of an exemplary battery pack during a discharging process is shown. The input parameter may include voltage, current and time. Charge or charge flow (Q) is calculated from the current flow and the time elapsed. The voltage has a unit of volt (v), and the charge flow has a unit of Amp*hour (Ah) or coulomb. As shown in FIG. 3, Vmax is the voltage of such a battery pack when it is fully charged or it is at its maximum allowable charge level. Vmin is the voltage of such a battery pack when it is depleted of charge or it reaches its minimum allowable charge level.

The curve of voltage versus charge can be empirically generated at constant level of discharge while monitoring the current flow over the discharge period until the voltage drops beyond a user-defined minimum limit (Vmin), shown by the vertical dotted line in FIG. 3. The current and the voltage follow the same or similar trend with increase in charging time. Different discharge rates may yield different voltage discharge curves for the same battery packs. In some embodiments, a technique such as extrapolation, interpolation, or averaging is used to get a representative curve. In one curve, when the voltage decreases beyond Vmin during discharge, such a battery pack shows a significantly higher voltage gradient and depletes more quickly. This lower limit point can be also referred as voltage collapse. A parameter V* defined as (V−Vmin)/(Vmax−Vmin) is a voltage distribution parameter as an indicator of the capacity of the battery pack to discharge. The parameter varies from 0 to 1. The higher the parameter, the higher degree this battery pack is capable of further discharge.

Referring to FIG. 4, a voltage gradient (∇V) is defined by Equation (1):

$$\overline{V} V = \vert \frac{{V}_{1} - {V}_{2}}{{Q}_{1} - {Q}_{2}} \vert \qquad ( 1 )$$

The voltage gradient is the voltage drop divided by the corresponding amount of the discharge of a battery pack. This is an indictor of impact of the discharge on the remaining capacity of the battery. A smaller value is consider as better. In a general expression, the voltage gradient or the gradient of battery voltage is defined below by Equation (2):

∇Vᵢ=(ΔVᵢ/ΔQᵢ) (2)

where ΔQᵢ is the discharge from i^{th} pack and ΔVᵢ is its resulting voltage drop.

Heterogeneous battery battery packs have varying voltage-charge-time characteristics. In the method provided in the present disclosure, the algorithm biases the discharge to battery packs that show lower voltage-over-charge gradient. In other words, one objective is to minimize the gradient of battery voltage as defined in Equation (1) or (2). The battery packs having lower voltage gradients are used for discharge at a higher priority. For each battery pack, the controller 60 is configured to iteratively select optimal discharge amount (e.g., Q₂ or ΔQ), which translates into the discharge share (Ωᵢ) in the power demand (D) for the whole system so as to reduce and/or control the voltage gradient (∇Vᵢ). The voltage gradient of each battery pack is mimimized. This effect of this low voltage gradient is summed over all the heterogenous battery packs in a system. This guarantees better stability for same charge throughput while making it easier to satisfy the dispatch power command passed on to a system having a plurality of battery packs.

The discharge share (Ωᵢ) in the total power demand (D) for a battery pack is calculated using Equation (3):

$${Ω}_{i} = \frac{V ( {Q}_{2} - {Q}_{1} )}{D} \qquad ( 3 )$$

The total power demand (D) is the total energy required in a unit time. V is the voltage level in the minimal interval of from V₁ to V₂. Q2−Q1 is the discharge (ΔQ). The discharge share can be represented in in percentage, and can be converted into a corresponding discharge rate based on the unit time and the corresponding discharge amount.

FIG. 4 illustrates how the dispatch shares (Ωᵢ) are calculated iteratively to minimize voltage gradient while satisfying the dispatch constraint. With every iteration a new Q₂ is selected and new Ωᵢ is calculated until all the total ∇V are minimized. The following equations define the model and the constraints.

For the plurality of battery backs (n packs in total) in a system, the total sum of the discharge shares is equal to 1 as shown in Equation (4):

$$1 = {\sum }_{i = 1}^{n} {Ω}_{i} \qquad ( 4 )$$

The operations to reduce the voltage gradient of each battery pack can be iterated multiple times and at different time intervals. The corresponding voltage gradient at a certain number of iteration can be calculated using Equation (5):

$$\overline{V} {V}_{i , k} = \vert \frac{{V}_{i , k} - {V}_{i , k + 1}}{{Q}_{i , k} - {Q}_{i , k + 1}} \vert \qquad ( 5 )$$

Equation (5) is for i^{th} battery pack and k^{th} iteration. The discharge share of the battery pack at a certain time can be calculated using Equation (6):

$${Ω}_{i , j} = \frac{{{V}_{i , j} ( {Q}_{2} - {Q}_{1} )}_{i , j}}{D} \qquad ( 6 )$$

Equation (6) is for i^{th} pack at j^{th} time. For the plurality of battery packs, the total amount of discharge is equal to the total power demand (D) as shown in Equation (7):

$$D = {\sum }_{i}^{n} {V}_{i} \cdot {( {Q}_{2} - {Q}_{1} )}_{i} \qquad ( 7 )$$

Equations (5) and (6) indicate the method to calculate the dispatches for individual battery packs. In some embodiments, the maximum dispatch (discharge) of each battery are identified. Equation (7) or Equation (4) indicates the dispatch constraint. Discharge energy is assumed to be delivered in unit time. Therefore, energy is synonymous with power for dispatch purposes. The output parameters include the discharge share or rate for each battery pack.

The system 100 includes a heterogeneous battery packs 20 integrated with bidirectional converter (or inverter) 10 connected to the grid or microgrid 85 that can be dispatched remotely or locally using this intelligent algorithm running in local or cloud-based controller 60. A data aggregation system, which activates/collects data from the battery packs, is presupposed to exist but not necessary.

In some embodiments, the algorithm requires prior knowledge of the voltage-charge gradient curve, which can be acquired during commissioning and subsequently updated as the battery packs age or wear out due to use/disuse.

FIGS. 5A-5B illustrate an exemplary method 200 for controlling discharge of a plurality of battery packs 20 in a system 100 in accordance with some embodiments. The plurality of battery packs 20 are heterogeneous battery packs selected from new batteries, second-use electric vehicle (EV) batteries, or combinations thereof. The plurality of battery packs 20 are connected in parallel, in series, or in a combination thereof.

Referring to FIG. 5A, at step 202, a total power demand needed to be dispatched from the system 100 is received by the controller 60. As described herein, a total power demand may be received from EMS 110.

At step 204, characteristic data of each battery pack 20 are collected to establish a first curve of voltage versus charge for each battery pack 20. The voltage and charge in this curve may be referred as the first set or initial values. An exemplary curve is shown in FIG. 3 as described above. The voltage versus charge (amp-hr) characteristics of each battery pack may be empirically obtained or derived for a set of frequently encountered discharge rates. This provides a family of curves that can be used to track the voltage trajectory of the packs for a given dispatch episode.

At step 206, a voltage gradient for each battery pack 20 is determined based on the first curve of voltage versus charge. As described in FIG. 4, Equation (1) or (2) can be used to calculate voltage gradient.

At step 210, the voltage gradient for each battery pack can be controlled and/or reduced to be below a predetermined threshold (ε) by changing charge and corresponding voltage of a respective battery pack. The charge and voltage, which can be referred as the second charge and the second voltage as compared to the initial values, provide a second curve of voltage versus charge. The resulting voltage gradient can be referred as the second or final voltage gradient.

In some embodiments, step 210 for controlling and/or reducing a corresponding voltage gradient of every battery pack includes steps 222, 224, and 226 as shown in FIG. 5B.

At step 222, it is assumed that all the plurality of battery packs 20 in the system 100 are used for discharging and power dispatch. A maximum voltage gradient and a corresponding first battery pack are identified among the plurality of battery packs.

At step 224, the maximum voltage gradient of the corresponding first battery pack is reduced or minimized by changing its charge and corresponding voltage. For example, in some embodiments, the voltage gradient is controlled to be below the predetermined threshold (ε).

At step 226, the steps of identifying and minimizing the maximum voltage gradient (steps 222 and 224) are then repeated among a remainder of the plurality of battery packs 20 to establish a second curve of voltage versus charge for each battery pack. As described for FIG. 4, Equations (5), (6), and (7) can be used.

The predetermined threshold (ε) may be any suitable number based on the type of battery packs. As described in FIG. 3, the suitable discharging range is within the range of from Vmax to Vmin. In some embodiments, a suitable predetermined threshold (ε) may be in a range of less than 2, for example, 0-1.5, 0-1, 0-0.5, when the voltage is in volt, and the charge is in Amp*hour (Ah).

Referring back to FIG. 5A, at step 212, a respective discharging share of each battery pack is calculated based on the charge and the voltage in the second curve of voltage versus charge of each battery pack and the total power demand needed to be dispatched. Equation (3) or (6) can be used as described above.

At step 214, power is discharged from the plurality of battery packs based on the respective discharging share of each battery pack. Instructions are sent from the controller 60 to each battery pack 20 and/or one or more converter 10 connected with the plurality of battery packs 20 for discharging based on the respective discharging share of each battery pack 20. In some embodiments, a certain battery pack 20 may be kept in idle if a respective discharging share of such a battery pack is about zero, or cannot be used under the condition constraints.

In some embodiments, the method 200 includes repeating some or all the steps to re-assign dispatch for the plurality of battery packs after the time interval ends or when a voltage collapse occurs to a battery pack. The interval can be defined by a user. For example, the time interval may be any time length from 10 second to 2 hours, for example, 1 minute, 2 minutes, 5 minutes, 10 minutes, 15, minutes, 30 minutes, or one hour. Every time a discharge share is changed or re-determined, a different discharge curve is used to determine the voltage gradient. In some embodiments, the discharging process of the plurality of battery packs is dynamically controlled by updating the respective discharging share or rate of each battery pack instantaneously with time.

Referring to FIG. 6, an exemplary block diagram 300 illustrates the steps and algorithm used according to the method 200 in some embodiments. Each block represents a step or a criterion.

In Block or step 302, the total power demand (i.e., the total dispatch level) (D) is received. In Block 304, the voltage versus charge characteristics of each battery pack is obtained or derived for a set of frequently encountered discharge rates. A family (N) of such curves will be obtained for a plurality (n) of battery packs in the system 100. In Block 306, a dispatch distribution among all the plurality of battery packs is assumed.

In Block 308, the voltage gradients of every battery pack in the curves are calculated. In Block 310, a voltage gradient distribution chart for all the packs is created, and the battery pack with the maximum voltage gradient is identified. And the voltage gradient is reduced to a suitable level, which is suitable for discharge and also good for the battery life. The maximum voltage gradient is reduced or minimized to be below a certain threshold (ε) by altering the charge and corresponding voltage based on curves obtained in Block 304. In Block 312, if the voltage gradient of such a battery is reduced or minimized to be below a certain threshold ε), the battery pack is assigned for a dispatch share or rate (step 212 of FIG. 5A). The procedures from Block 306 to Block 312 can be repeated by cycles (steps 210 of FIG. 5A and steps 222 to 226 of FIG. 5B). Such an approach is used to reduce gradients for other packs unless they are below the threshold (ε), maintaining the dispatch constraints as shown in Equation (7). In other words, the program in the controller 60 search for a combination of discharging rates so that ∇Vₘₐₓ is below a threshold (ε).

As the output, dispatch shares are assigned to each and every battery pack. If discharge rate changes, an alternate curve will be used to generate the voltage distribution.

As illustrated in FIG. 6, in some embodiments, after the dispatch energy requirement is obtained by a battery pack management system, an initial distribution of dispatches is assumed among packs. The max gradient is minimized below a user-defined parameter (ε) by redistribution of dispatches among packs while maintaining the fixed total dispatch. Once the maximum voltage gradient is minimized, individual pack dispatch energy is calculated. Even if the battery pack is large, its dispatch energy may be low due to higher voltage gradient. While the dispatch energy from a smaller battery may be higher if its voltage gradient is lower. In any case, the program in the controller 60 ensures that the maximum dispatch capacity of each pack is never violated.

In case of large drops in voltages in certain instances pack-specific time constraints may be used to force certain packs to dispatch at a faster or slower rate or stop discharge. In some embodiments, to reduce the sudden changes in dispatch distribution within battery packs due to voltage variations, Ωᵢ can be calculated using window averaging (instead of instantaneously):

Ωᵢ=Ω̅ᵢ

In some embodiments, to reduce fluctuations due to fast moving voltage curve, window averaging can be applied to calculate average voltages over a predefined moving window can be used.

As shown in FIG. 6, these steps are repeated for every new dispatch.

All battery packs need to be cycled at different discharge rates to obtain the characteristic curves. Most battery systems collect (or provide) voltage and current readings. These are used to calculate the charge and energy flows.

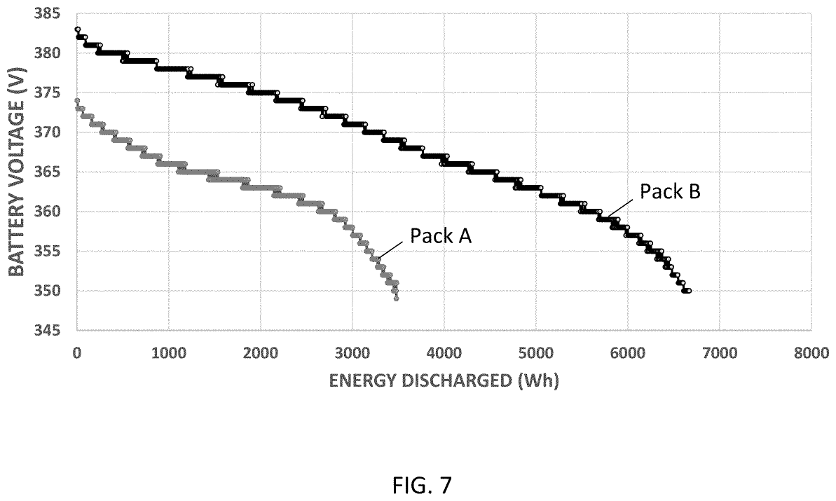

FIG. 7 shows two exemplary battery packs, Pack A and Pack B, with different voltage-charge features being dispatched with the program and algorithm provided in the present disclosure. Both battery packs are of identical brand.

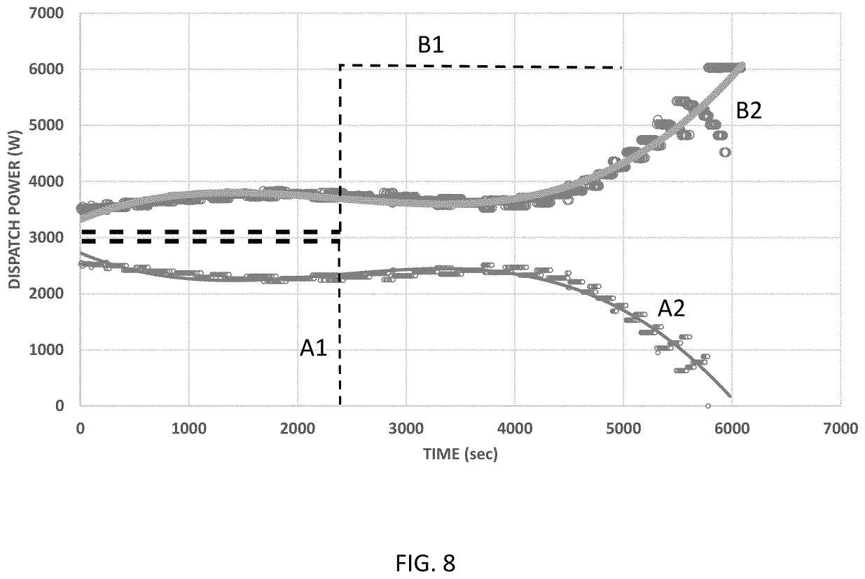

FIG. 8 shows the changes in power dispatch of the two exemplary battery packs with time. The power demand is 6,000 watts. The dotted lines A1 and B1 illustrate the same battery packs using the existing technologies, in which the two battery packs are discharged at almost the same share first until the weak pack A dies and Pack B has to carry all the discharging need. The discharge in this way leads to large stress and degradation to both battery packs.

Lines A2 and B2 illustrate the new trajectory implemented based on the controller and the method provided in the present disclosure to demonstrate the performance of the battery packs. The approach manages proportionate share of the dispatch based on the voltage differential. Pack A with lower voltage is dispatched at a lower power share. Reduced discharge leads to lower degradation and balances performance between the battery packs.

The system, the controller, and the method provided in the present disclosure offer many advantages. For example, a variety of battery packs such as used EV battery packs having different quality can be used. No pre-selection or dismantle of the battery packs are needed. If one pack and/or one converter fails to response, the system still has capability to supply power load to satisfy the power demand. The system, the controller, and the method extend the life of each battery packs, and they also offer flexibility in maintaining and upgrading the system as well.

The methods and system described herein may be at least partially embodied in the form of computer-implemented processes and apparatus for practicing those processes. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, or any combination of these mediums, wherein, when the computer program code is loaded into and executed by a computer, the computer becomes an apparatus for practicing the method. The methods may also be at least partially embodied in the form of a computer into which computer program code is loaded and/or executed, such that, the computer becomes an apparatus for practicing the methods. When implemented on a general-purpose processor, the computer program code segments configure the processor to create specific logic circuits. The methods may alternatively be at least partially embodied in a digital signal processor formed of application specific integrated circuits for performing the methods. The computer or the control unit may be operated remotely using a cloud based system.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a plurality of battery packs;
one or more power converters, each power converter coupled with at least one of the plurality of battery packs and configured to convert direct current (DC) from one battery pack to alternating current (AC) or vice versa; and
a controller coupled to the plurality of battery packs and the one or more power converters, the controller comprising one or more processor and at least one tangible, non-transitory machine readable medium encoded with one or more programs configured to perform steps of:
receiving a total power demand needed to be dispatched from the system;
collecting characteristic data of each battery pack to establish a first curve of voltage versus charge for each battery pack;
determining a voltage gradient for each battery pack based on the first curve of voltage versus charge;
controlling the voltage gradient for each battery pack to be below a predetermined threshold by changing charge and corresponding voltage of a respective battery pack to provide a second curve of voltage versus charge;
calculating a respective discharging share of each battery pack based on the charge and the voltage in the second curve of voltage versus charge of each battery pack and the total power demand needed to be dispatched; and
providing signals with instructions to the plurality of battery packs and the one or more power converters for discharging power from the plurality of battery packs based on the respective discharging share of each battery pack and/or keeping a certain battery pack idle.

2. The system of claim 1, wherein the step of controlling the voltage gradient for each battery pack to be below a predetermined threshold comprises steps of:
identifying a maximum voltage gradient and a corresponding first battery pack among the plurality of battery packs;
minimizing the maximum voltage gradient of the corresponding first battery pack to be below the predetermined threshold by changing its charge and recalculating corresponding voltage; and
repeating the steps of identifying and minimizing the maximum voltage gradient among a remainder of the plurality of battery packs to establish a second curve of voltage versus charge for each battery pack.

3. The system of claim 1, wherein the plurality of battery packs are heterogeneous battery packs selected from new batteries, second-use electric vehicle (EV) batteries, or combinations thereof.

4. The system of claim 1, wherein the plurality of battery packs are connected in parallel, in series, or in a combination thereof.

5. The system of claim 1, further comprising one or more battery power management unit (BPMU), each BPMU connected with one or more battery packs and configured to monitor the one or more battery packs and provide characteristic data of the one or more battery packs to the controller.

6. The system of claim 1, wherein the system is an electrical energy storage system, and the total power demand is provided from an upper level energy management system.

7. The system of claim 1, wherein the controller is configured to dynamically control discharging of the plurality of battery packs by updating the respective discharging share of each battery pack instantaneously with time.

8. A controller for controlling discharge of a system comprising a plurality of battery packs, comprising one or more processor and at least one tangible, non-transitory machine readable medium encoded with one or more programs configured to perform steps of:
receiving a total power demand needed to be dispatched from the system;
collecting characteristic data of each battery pack to establish a first curve of voltage versus charge for each battery pack;
determining a voltage gradient for each battery pack based on the first curve of voltage versus charge;
controlling the voltage gradient for each battery pack to be below a predetermined threshold by changing charge and corresponding voltage of a respective battery pack to provide a second curve of voltage versus charge;
calculating a respective discharging share of each battery pack based on the charge and the voltage in the second curve of voltage versus charge of each battery pack and the total power demand needed to be dispatched; and
providing signals with instructions to the plurality of battery packs and one or more power converters for discharging power from the plurality of battery packs based on the respective discharging share of each battery pack and/or keeping a certain battery pack idle.

9. The controller of claim 8, wherein the step of controlling the voltage gradient for each battery pack to be below a predetermined threshold comprises steps of:
identifying a maximum voltage gradient and a corresponding first battery pack among the plurality of battery packs;
minimizing the maximum voltage gradient of the corresponding first battery pack to be below the predetermined threshold by changing its charge and corresponding voltage; and
repeating the steps of identifying and minimizing the maximum voltage gradient among a remainder of the plurality of battery packs to establish a second curve of voltage versus charge for each battery pack.

10. The controller of claim 8, wherein the plurality of battery packs are heterogeneous battery packs selected from new batteries, second-use electric vehicle (EV) batteries, or combinations thereof.

11. The controller of claim 8, wherein the plurality of battery packs are connected in parallel, in series, or in a combination thereof.

12. The controller of claim 8, wherein the controller is configured to dynamically control discharging of the plurality of battery packs by updating the respective discharging share of each battery pack instantaneously with time.

13. The controller of claim 8, wherein the controller is configured to discharge power from the plurality of battery packs to a grid or load.

14. A method for controlling discharge of a system comprising a plurality of battery packs through a controller therein, comprising:
receiving a total power demand needed to be dispatched from the system;
collecting characteristic data of each battery pack to establish a first curve of voltage versus charge for each battery pack;
determining a voltage gradient for each battery pack based on the first curve of voltage versus charge;
controlling the voltage gradient for each battery pack to be below a predetermined threshold by changing charge and corresponding voltage of a respective battery pack to provide a second curve of voltage versus charge;
calculating a respective discharging share of each battery pack based on the charge and the voltage in the second curve of voltage versus charge of each battery pack and the total power demand needed to be dispatched; and
discharging power from the plurality of battery packs based on the respective discharging share of each battery pack.

15. The method of claim 14, wherein the step of controlling the voltage gradient for each battery pack to be below a predetermined threshold comprises steps of:
identifying a maximum voltage gradient and a corresponding first battery pack among the plurality of battery packs;
minimizing the maximum voltage gradient of the corresponding first battery pack to be below the predetermined threshold by changing its charge and corresponding voltage; and
repeating the steps of identifying and minimizing the maximum voltage gradient among a remainder of the plurality of battery packs to establish a second curve of voltage versus charge for each battery pack.

16. The method of claim 14, wherein a certain battery pack idle is kept in idle if a respective discharging share of a certain battery pack is about zero.

17. The method of claim 14, wherein the plurality of battery packs are heterogeneous battery packs selected from new batteries, second-use electric vehicle (EV) batteries, or combinations thereof.

18. The method of claim 14, wherein the plurality of battery packs are connected in parallel, in series, or in a combination thereof.

19. The method of claim 14, wherein discharging of the plurality of battery packs is dynamically controlled by updating the respective discharging share or rate of each battery pack instantaneously with time.

20. The method of claim 14, further comprising sending instructions from the controller to each battery pack and/or one or more converter connected with the plurality of battery packs for discharging based on the respective discharging share of each battery pack.
